(19) United States
(12) Patent Application Publication
(10) Pub. No.: US 2003/0023511 A1
(43) Pub. Date: Jan. 30, 2003

(54) Automated system and method for tracking online activity to initiating information source

(76) Inventor: Donald A. Gardner SR., Greenville, SC (US)

Correspondence Address: Frances Barnes Elliott, Esq., Dority & Manning, Attorneys at Law, P.A., P.O. Box 1449, Greenville, SC, 29602, US

(21) Appl. No.: 09/918,133

(22) Filed: Jul. 30, 2001

(51) Int. Cl. G06F 17/60

(52) U.S. Cl. 705/27

(57) ABSTRACT

An automated tracking system and method is provided which allows the evaluation of the effectiveness of advertisements directing consumers to sites on the Internet. The tracking system uses the Web address entered by a consumer to identify the source of information leading the consumer to the Website of interest. As the consumer navigates the Website, the tracking system associates this source-identifying data with any product transactions effected by the consumer and records the information for reporting and analysis. The tracking system also retains the source-identifying data in the event the consumer leaves the Website and later returns or goes offline to purchase a product.

### BACKGROUND OF THE INVENTION

A portion of the disclosure of this patent document contains material which is subject to copyright protection. The copyright owners have no objection to the facsimile reproduction by anyone of the patent disclosure, as it appears in the Patent and Trademark Office patent files or records, but otherwise reserve all copyrights whatsoever.

The present invention relates to an improved tracking system for evaluating the effectiveness of advertising and other information sources directing consumers to sites on the Internet.

Various systems have been designed to measure the effectiveness of the wide variety of advertising and other information media based on resulting interest in the advertised product. Many such systems attempt to track goods or service sales and inquiries to the information source through which a consumer received an initial impression of the selected product. A typical system has included requesting this lead or source information from the consumer either through a sales order form, questions from a sales representative, or an after sale survey.

More and more consumers now go online to locate products of interest. Consequently, many of today's print and television or radio advertisements include a uniform resource listing (URL), commonly known as a Web address, directing the consumer to a particular Website for further information about the advertised product. With the growth of commerce over the portion of the Internet known as the World Wide Web, new methods are needed to track consumers' online activity as they make inquiries about, research, and eventually purchase products and services.

Prior tracking methods include counting the number of visits or “hits” to a particular Website, but generally include no link to a specific advertising source. Methods have been developed for tracking a visit to a Website to a particular banner advertisement which is linked to the Website from another portion of the Internet. However, methods for linking online activity to print media or television and radio advertising have previously needed participation by the consumer. Requiring information to be obtained from the user creates the potential for receiving faulty information, receiving no information, and causing discouraging inconvenience to the buyer.

Accordingly, it can be seen that a need exists for an automated system and method which is transparent to the consumer and retains the ability to evaluate the effectiveness of offline advertising even when purchases and product inquiries are made online.

### SUMMARY OF THE INVENTION

The present invention recognizes and addresses the foregoing disadvantages, and others, of prior art construction and methods.

Accordingly, it is an object of the present invention to provide an improved design for an automated system and method for tracking online activity to the information or advertising source which initially led a consumer to a given Web address. More particularly, it is an object of the present invention to provide a system and method for recording both online and offline product transactions along with the associated initiating information source for reporting and marketing analysis.

It is also an object of the present invention to provide a method which is transparent to the consumer for linking an initial information source to final product transactions.

It is an additional object of the present invention to retain intermediate sources of information, such as catalogs, so that information is recorded about all contributing sources from the customer's initial awareness of the product to the end sale.

It is a still further object of the present invention to retain the initiating information source in the event that a user leaves the Website or goes offline and returns later to effect a product transaction.

It is a still further object of the present invention to facilitate contractual arrangements in which the profits from a particular sale go to the party responsible for a consumer's initial awareness of the purchased product.

Additional objects and advantages of the invention will be set forth in part in the following description, or may be obvious from the description, or may be learned through practice of the invention.

Some of these objects are achieved by the design of an automated tracking system and method based on a catalog of directory pathnames serving as source codes. Each advertising or information source to be considered within the system is encoded with a source code which serves to identify it as the lead which created a consumer's initial awareness of a product or service featured on a Website. The encoded source code includes a Web address followed by a source-identifying directory pathname. When a user decides to access the Website referenced by the advertisement or information source, the user will type in the entire Web address including the source-identifying information. The tracking system then uses each part of the Web address to build the series of display pages which make up the Website for display to the user.

In a preferred embodiment, the source-identifying pathname is used as an index into a database which includes a catalog of predetermined product codes encompassing all products and services to be featured on the Website. As the user navigates the Website, using, for example, a browser, the tracking system builds Web pages which include the product codes retrieved from the database and derived using the pathname or source identifier. In one embodiment, each product code includes at least the pathname followed by a product identifier.

In a preferred embodiment, the automated tracking system accepts user input with respect to product transactions as the user is navigating the Website. The tracking system records all such user activity including transaction information and the associated product information. In one embodiment, transaction types will include an inquiry, a search, and a purchase.

In a preferred embodiment, the product information recorded includes the product codes used to build the Web pages. Accordingly, each product transaction recorded also contains the information included in the product code regarding the identification of the path or source code which was initially accepted from the user. The information recorded about product transactions is later used to formulate reports to indicate the effectiveness of advertising and information sources. In one embodiment, a user activity report can be sorted by source code so that the report indicates which products were purchased or researched as a result of a consumer viewing the identified advertisement. User activity reports might also be sorted based upon product identifier or transaction type.

In a preferred embodiment, the tracking system would retain source-identifying information in the event that a user accesses a particular Website and then leaves the site or goes offline. In a preferred embodiment, when a user enters a particular pathname including a source code, the automated tracking system makes a request to a browser on the user's computer through which the user is accessing the Internet. The request includes the source code which the browser is asked to record on the user's computer for later retrieval. In one embodiment, the recording of this information is accomplished using a cookie.

Whenever the user accesses the given Website, the automated tracking system also requests that the browser check the user's computer for such stored information or cookie. The tracking system would then use pre-coded selection criteria to choose between the source-identifying pathname entered by the user and the source code previously stored or cookied on the user's computer to use as an index into the database of product codes. For instance, if the address typed in by the user consisted of the Web address with no source directory path, that is, the source directory path was null, the system would look to the cookie to see if the user had been previously directed to the Website through one of the encoded advertisements or information sources.

In one embodiment, the directory pathname or source code entered by the user along with the Web address might indicate a catalog of products as the source of information. In that instance, the tracking system would look to the stored or cookied information on the user's computer to determine if the user had previously visited the Website to order the catalog. If the user was initially directed to Website by an advertisement source other than the catalog, a source code or pathname identifying that source will be recorded on the user's computer. In that case, both sources of information will be logged with any subsequent product transaction. In one embodiment, the catalog code will be included on the Web pages with the associated product codes.

The accompanying drawings, which are incorporated in and constitute a part of this specification, illustrate the described embodiments of the invention and, together with the description, serve to explain the principles of invention.

### BRIEF DESCRIPTION OF THE DRAWINGS

A full and enabling disclosure of the present invention, including the best mode thereof and directed to one of the ordinary skill in the art, as set forth in the specification, which makes reference to the appended drawings in which:

FIG. 1 is a block diagram showing the components of an automated tracking system designed in accordance with the present invention;

FIG. 2 is a flowchart of the processes associated with one embodiment of an automated tracking system and method designed in accordance with the present invention;

FIG. 3 is a block diagram showing the method from a consumer's point of view of an automated tracking system designed in accordance with the present invention;

FIG. 4a is an example of one embodiment of an encoded information source for the automated tracking system illustrated in FIG. 2;

FIG. 4b is an example of one embodiment of an initial Web page for the automated tracking system illustrated in FIG. 2;

FIG. 4c is an example of one embodiment of a product inquiry Web page of the automated tracking system illustrated in FIG. 2;

FIG. 4d is an example of one embodiment of a product purchase Web page of the automated tracking system illustrated in FIG. 2; and

FIG. 5 is one embodiment of an activity report for the automated tracking system illustrated in FIG. 2.

Repeat use of reference characters in the present specification and drawings is intended to represent same or analogous features or elements of the invention.

### DETAILED DESCRIPTION OF THE PREFERRED EMBODIMENT

Reference will now be made in detail to the presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations as come within the scope of the appended claims and their equivalents.

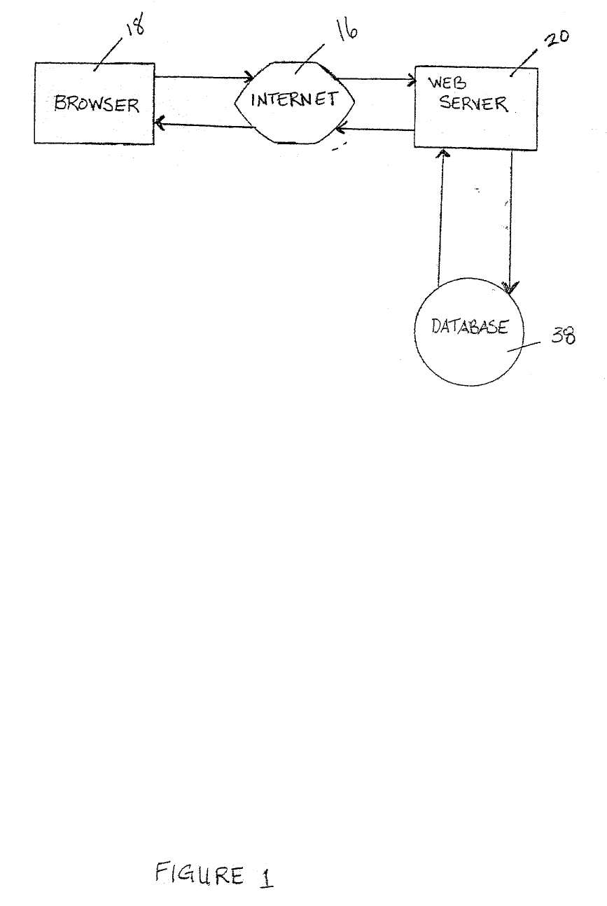

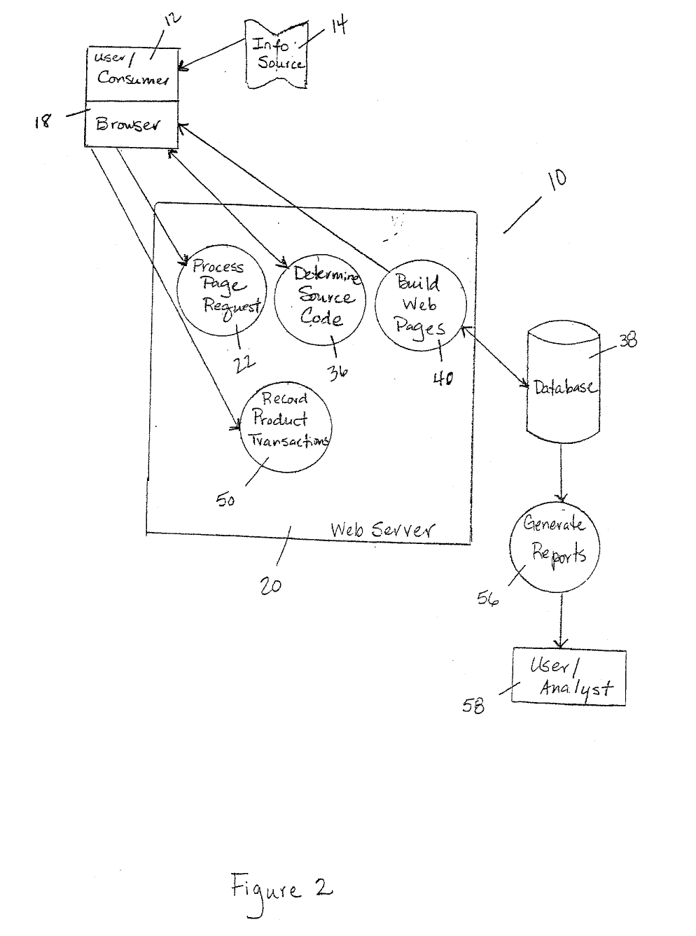

The present invention is concerned with an improved system and method for evaluating the effectiveness of advertising and other information sources by tracking a particular source to resulting online activity by consumers, such as product transactions. Accordingly, FIGS. 1 and 2 depict a presently preferred embodiment of an automated system 10 for tracking online product transactions made by a consumer 12 to the advertising or information source 14 through which the consumer 12 first gained an impression of the product.

In a preferred embodiment, the automated tracking system 10 of the present invention contemplates the user/consumer 12 using a computer to access a wide area network, generally the Internet 16, via a browser 18. Commonly used browsers include Netscape Navigator™, and Internet Explorer™ by Microsoft® Corporation.

The user requests access to a Website by entering the URL or Web address which was included in the advertising source 14. The user's page request is routed over the Internet 16 to the appropriate Web server 20 for processing 22. In a preferred embodiment, the present invention uses Windows 2000 Server™ by Microsoft® Corporation and its associated software, Internet Information Services™ (IIS) 5.0. In response to a request for displaying Web pages, the Web server 20 uses off-the-shelf (OTS) software designed for the task, such as Microsoft® Visual Basic® Scripting Edition.

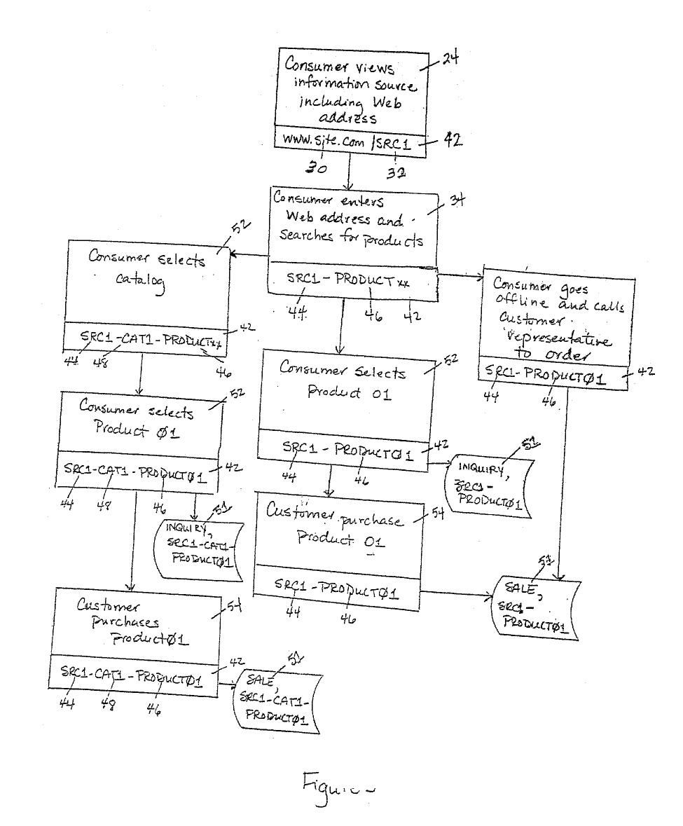

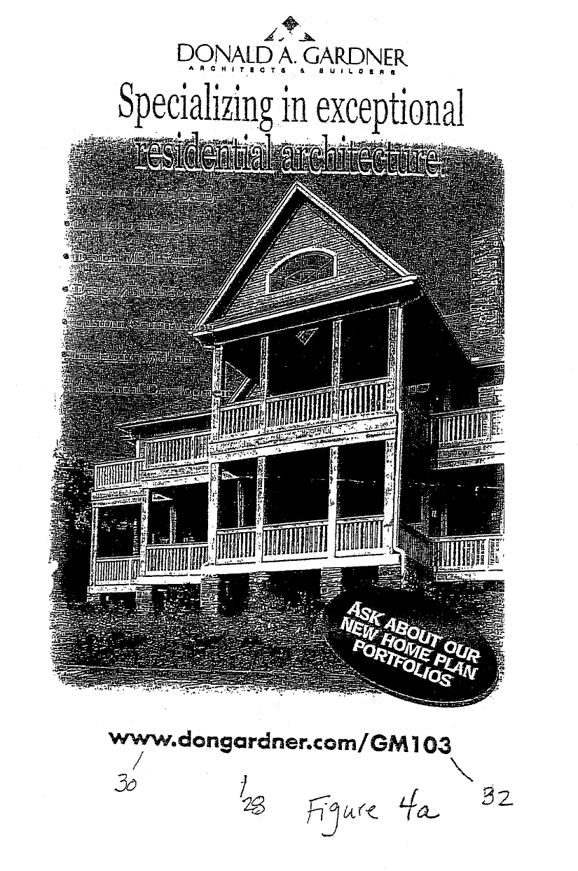

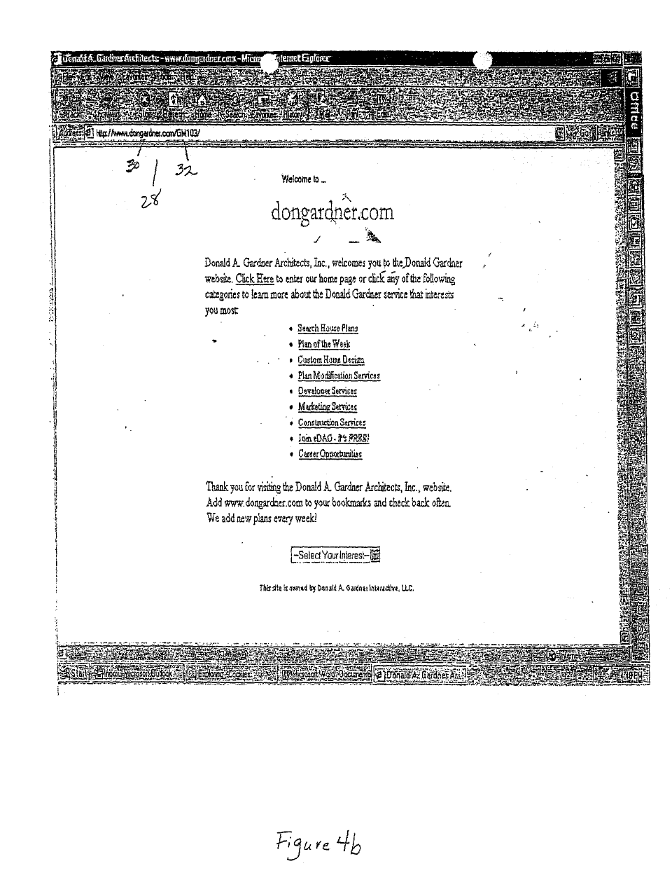

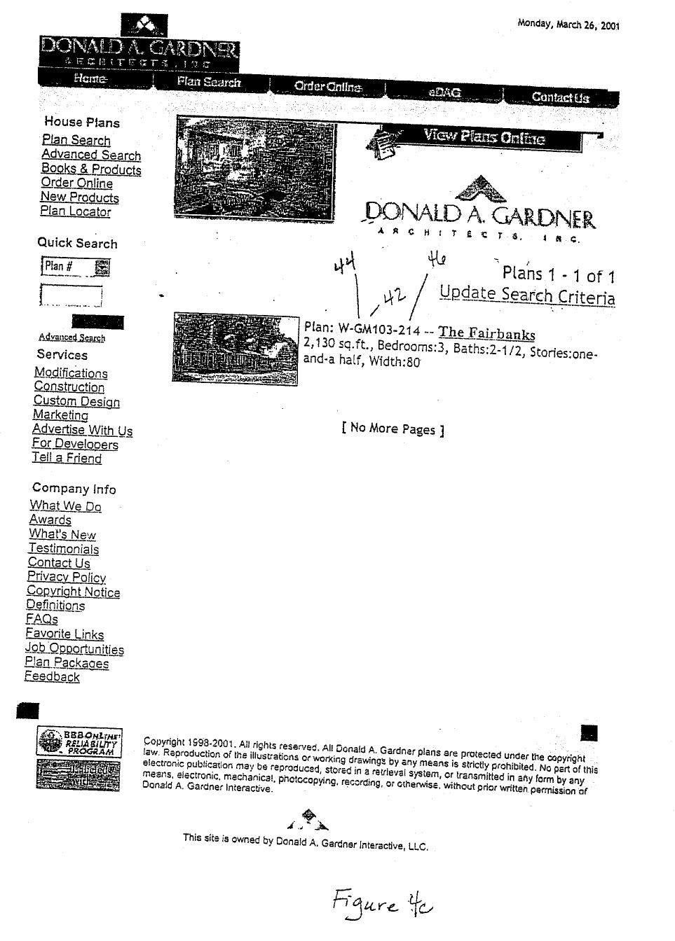

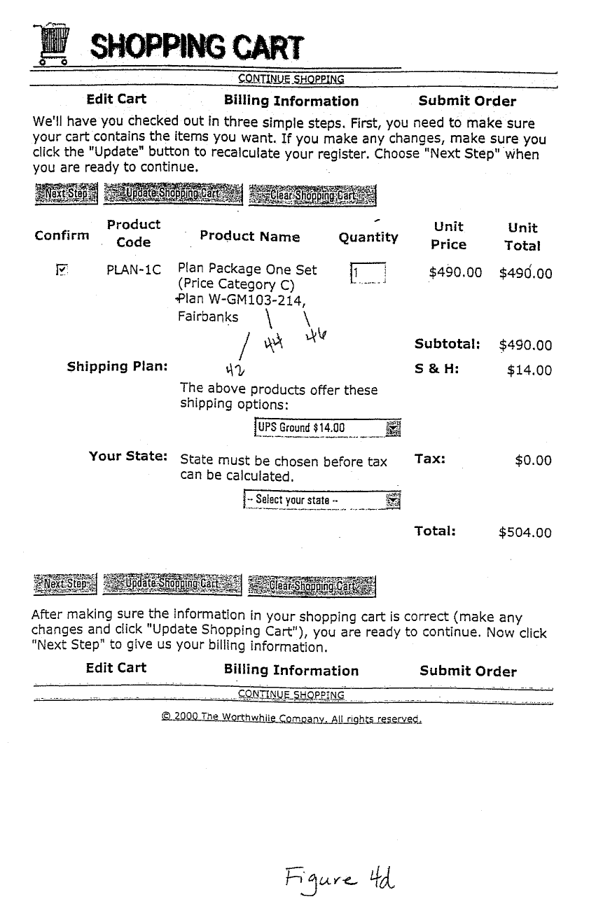

Prior to displaying the Web pages associated with the requested site to the user, the system 10 must build the appropriate Web pages using the server based on the information supplied by the user 12. In describing this process, reference will also be made to FIGS. 3 and 4a-d. FIGS. 4a-d show an exemplar series of Web pages using the present invention in an application relating to architectural designs.

As shown in FIG. 3, the user/consumer initially becomes aware of a product or service through an information source or advertisement 24 such as the one 26 shown in FIG. 4a. Each advertisement 26 is encoded with a Web address 28 directing the user 12 to an online site for more information about the company, product, or service featured in the ad. In a preferred embodiment, the encoded Web address 28 includes a standard URL 30 followed by an extended directory pathname 32 to serve as an indicator of source. The entire address 28 is entered 34 by the user 12 as shown in FIGS. 3 and 4b.

Returning to FIG. 2, the automated tracking system and method 10 determines the source code 36 to be used in accessing the database 38 and building the Web pages 40 for display. To determine the source code 36, the system 10 initially strips the directory pathname 32 from the Web address 28 entered by the user 12. The source code component 36 of the system then makes a request of the browser 18 to retrieve from the user's 12 computer any previously stored source identifier.

If no such stored identifier exists, the source code component merely requests that the browser 18 record on the user's 12 computer the current directory pathname 32 as a source identifier.

In a preferred embodiment, this recordation is accomplished by the browser 18 using a cookie. A cookie is essentially a piece of data deposited onto the user's computer system which may be accessed whenever the user returns to the cookie-depositing site. Generally, the returning user must be using the same computer, browser, and login as when the deposit was made. This depositing of information is generally transparent to the user.

Returning to the process, if the source code component 36 does find a source identifier cookied on the user's 12 computer, the component 36 must then determine whether to use the current directory path 32 entered by the user or the retrieved source identifier as the source code for building the Web pages to be displayed to the user.

The logic for this determination is as follows. If the directory path 32 entered by the user is null, that is, the user merely entered a standard URL 30, the source code to be used is the stored or cookied source identifier. If the cookie contains a source identifier and the user 12 has entered a new directory path 32, the directory path 32 is used as the source code, and a request is made to the browser 18 to overwrite the source identifier in the cookie with the new directory path 32.

An alternative scenario to this, in one embodiment, is when the user enters a catalog number as the new directory path 32. A catalog number indicates that the user is selecting products or services based on information obtained from catalog or other similar listing and description of the offerings of a company. In that instance, both the source identifier retrieved from the cookie and the catalog number entered as the directory path 32 will be used as the source code to build the Web pages.

Once the source code has been determined, the component of the system which builds Web pages 40 uses the source code as an index to access the database 38 and retrieve information to be included in the Web pages. In one embodiment, the Web pages component 40 also uses the session state stored on the server 20 to determine which data to retrieve from the database. The information in the database can be tailored to the particular application utilizing the tracking system 10, and can be creatively chosen to alter the Web pages depending upon the source-identifying data and any information that data conveys about the user/consumer 12.

In a preferred embodiment, the information retrieved from the database includes product codes to be associated with the various products featured on the Website. As shown in FIGS. 3 and 4c, the product codes retrieved from the database 42 include the source code 44 serving as an indicator of source, and a product code 46 to indicate a particular product. As mentioned earlier, if a customer is working from a catalog, the product codes 42 may also include a catalog number 48.

Other information which the Web pages component 40 of the system 10 may retrieve from the database 38 in order to build the Web pages includes contract or pricing information which varies according to the information source responsible for the user's 12 visit to the Website. Essentially, the database 38 may be designed to contain any information which the designer of the Website would like to vary based upon where the consumer gained his initial impression of the Website and its offerings.

For example, in one embodiment, the profits from a sale might be divided between the manufacturer of a product and the publisher of a trade magazine featuring that product. The tracking system 10 of the present invention allows the manufacturer of the product to determine with particularity which sales require such a profit split.

The Web pages component 40 uses the data retrieved from the database along with the Hypertext Markup Language (HTML) in the asp file to build the final Web pages. After the Web pages have been built and displayed to the user, the system 10 allows the user to navigate the Website using the Web server 20. If a user decides to leave the Website or go offline before completing a product transaction, the associated source information is not lost because the source identifier cookied on the user's 12 computer remains and can be accessed if the user returns to the site to complete product transactions at a later date.

If the consumer decides to go offline and make a purchase by telephone call to a customer representative, the source information is also retained. Because the product codes relayed to the customer representative were obtained by the consumer from the Website, the product codes recorded for the phone order also include the source-identifying information.

As the user navigates the site, any transactions made with respect to products are recorded 50 in the database 38. As shown in FIG. 3, examples of product transactions include, among others, inquiries 52 and sales 54. The database entry associated with such a transaction would include a transaction type 51, indicating for example whether it was a sale or an inquiry, along with the product code 46 which as described earlier includes all sourcing information.

As an example, the entry for the purchase of a house plan shown in FIG. 4d would include the fact that it was a purchase as well as the product code W-GM103-214. The product code 46 (214) indicates the particular house plan purchased and the source code 44 (GM-103) indicates that the user came to the Website and purchased this product as a result of viewing the magazine ad shown in FIG. 4a.

In a preferred embodiment, the information is stored in a relational database such as Microsoft® SQL Server™, and the data is manipulated using stored procedures written in a relational database language such as Transact-SQL.

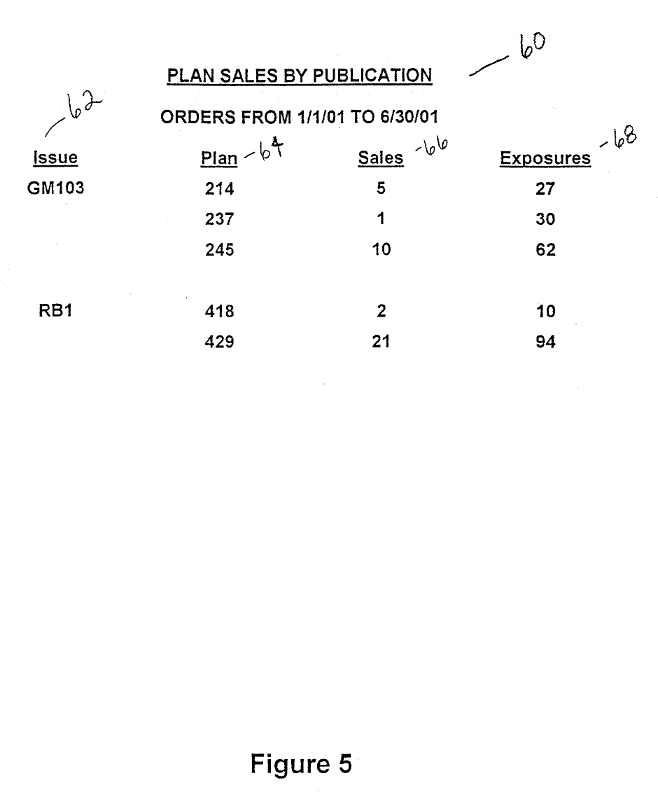

The final component of the system is the one for generating reports 56. This component retrieves a variety of information from the database 38 and produces reports which include an analysis of that information for a user/analyst 58. An example of such an activity report is shown in FIG. 5. The report 60 of FIG. 5 indicates an advertising source 62, the products 64 included in that advertising source 62, and the number of times that a product was sold 66 or viewed 68 as a result of being included in the ad source 62. Other reports might include the dollar amount sold as a result of a particular advertisement, or might group advertisements according to type such as magazine, newspaper, radio, or television.

It can thus be seen that the present invention provides a system and method for evaluating the effectiveness of individual advertising and information is sources which lead a customer to research or purchase products and services online. The system and method is transparent to the consumer and facilitates evaluation by tracking a source to resulting product transactions and recording this information for analysis and review.

While preferred embodiments of the present invention have been described above, it is to be understood that any and all equivalent realizations of the present invention are included within the scope and spirit thereof. Thus the embodiments depicted are presented by way of example only and are not intended as limitations upon the present invention. While particular embodiments of the invention have been described and shown, it will be understood by those of ordinary skill in this art that the present invention is not limited thereto since many modifications can be made. Therefore, it is contemplated that any and all such embodiments are included in the present invention as may fall within the literal or equivalent scope of the appended claims.

What is claimed is:

1. A system for tracking an initiating information source to associated product transactions by a user using a computer to access a wide area network, comprising:
a plurality of predetermined directory path names, each said path name corresponding to at least one said initiating source;
path selection means for selecting at least one said path name;
a list of predetermined product codes, each said code corresponding to at least one said product;
code selection means for selecting at least one said product code from said catalog using said selected path name;
a first logic means for building at least one display page for display on said user computer using at least one said selected product code;
navigation means for allowing said user to access at least one said display page using said selected path name;
a first acceptance means for accepting at least one said product transaction from said user and associating said product transaction with at least one said selected product code;
a storage component for recording each said accepted product transaction with each associated product code; and
a reporting component for reporting each said recorded product transaction.

2. The tracking system of claim 1, wherein each said display page forms a portion of a Website.

3. The tracking system of claim 2, wherein each said directory path name comprises an address for said Website followed by a source directory code.

4. The tracking system of claim 3, wherein said directory path name further comprises a catalog identifier.

5. The tracking system of claim 3, wherein each said product code is comprised of at least one said source directory code followed by a product identifier.

6. The tracking system of claim 5, wherein said source directory code is null.

7. The tracking system of claim 5, wherein said product code further comprises a catalog identifier.

8. The tracking system of claim 2, wherein said navigation means comprises a browser on said user computer.

9. The tracking system of claim 8, further comprising recording means for sending a request to said browser to record a source identifier on said user computer.

10. The tracking system of claim 9, wherein each said directory path name is comprised of an address for said Website followed by a source directory code.

11. The tracking system of claim 10, wherein each said product code is comprised of at least one said source directory code followed by a product identifier.

12. The tracking system of claim 11, wherein said product code further comprises a catalog identifier.

13. The tracking system of claim 10, wherein said source identifier comprises said source directory code.

14. The tracking system of claim 11, wherein said source directory code is null.

15. The tracking system of claim 13, wherein said path selection means further comprises:
a second acceptance means for accepting at least one said path name from said user;
retrieval means for reading said stored source identifier from said user computer; and
a second logic means for choosing between said stored source identifier and said accepted path name for use by said code selection means.

16. A method for tracking at least one advertising source to online activity by a user using a computer with a browser to access a wide area computer network, comprising the steps of:
encoding each said advertising source with a predetermined source identifier;
accepting one said source identifier from said user;
directing said browser to record said source identifier on said user's computer;
using said source identifier to build a series of display pages with predetermined product information for display on said user's computer;
allowing said user to navigate among said display pages;
recording user activity involving said product information; and
formulating an activity report tabulating said user activity.

17. The tracking method of claim 16, further comprising for the steps of:
using said source identifier to retrieve at least one stored product code;
including each said retrieved product code for display in at least one said display page;
allowing said user to select at least one said product code from at least one said display page;
accepting user action input regarding said selected product code; and
recording said user action and said associated product code as said user activity;
wherein said report tabulates each said user action and said associated product code.

18. The tracking method of claim 16, further comprising the steps of:
retrieving said recorded source identifier;
selecting between said recorded source identifier and said source identifier accepted from said user for use in building said display pages.

19. The tracking method of claim 16, wherein each said display page forms a portion of a Website.

20. The tracking method of claim 19, wherein each said source identifier comprises an address for said Website followed by a directory path name.

21. The tracking method of claim 20, wherein each said source identifier further comprises a catalog identifier.

22. The tracking method of claim 17, wherein each said product code includes at least one said source identifier.

23. The tracking method of claim 17, wherein said user action is a search.

24. The tracking method of claim 17, wherein said user action is a purchase.

25. The tracking method of claim 16, wherein said activity report is sorted by said source identifier.

26. A system for tracking an initiating information source to associated online activity by a user using a browser to access a Website via wide area network, comprising:
a plurality of predetermined directory path names, each said path name corresponding to at least one said initiating source;
a first acceptance means for accepting at least one said path name from said user;
recording means for sending a request to said browser to record a source identifier on said user computer;
retrieval means for retrieving said source identifier from said user computer;
a first logic means for choosing either said retrieved source identifier or said accepted path name to serve as a source code;
a catalog of product codes;
a first selection means for selecting at least one said product code from said catalog using said source code;
a second logic means for building at least one said Website display page for display on said user computer using at least one said selected product code;
navigation means for allowing said user to access at least one Web page using said accepted path name;
a second acceptance means for accepting at least one product transaction from said user and associating said product transaction with at least one said selected product code;
a storage component for recording each said accepted product transaction with each associated product code; and
a reporting component for reporting each said recorded product transaction.

27. The tracking system of claim 26, wherein said path name comprises an address for said Website.

28. The tracking system of claim 26, wherein said path name comprises an address for said Website followed by a source directory path.

29. The tracking system of claim 28, wherein said source identifier comprises a source directory path.
